(19) United States
(12) Patent Application Publication
(10) Pub. No.: US 2026/0316631 A1
(43) Pub. Date: Oct. 15, 2026

(54) VEHICLE SEAT WITH HIGH-AVAILABILITY WEIGHT DETECTION

(71) Applicant: Brose Fahrzeugteile SE & Co. Kommanditgesellschaft, Coburg, Coburg (DE)

(72) Inventors: Florian POHL, Ebersdorf (DE); Alex KROMER, Stegaurach (DE); Christian HERRMANN, Großheirath (DE); Adrian SCHINDHELM, Sonneberg (DE); Andreas HARTLEB, Weidhausen (DE)

(21) Appl. No.: 19/557,869

(22) Filed: Mar. 5, 2026

(30) Foreign Application Priority Data
Mar. 7, 2025 (DE) 102025108810.1

(51) Int. Cl. B60N 2/00; B60N 2/02

(52) U.S. Cl. CPC B60N 2/0025; B60N 2/0244

(57) ABSTRACT

A vehicle seat including a seat assembly, a backrest sub-assembly, a floor assembly bearing at least the seat assembly, an adjustment device for adjusting the seat assembly and/or the backrest sub-assembly relative to the floor assembly with a drive apparatus, and a control system coupled to the drive apparatus. It is provided that the control system be configured to perform the following step in a first operating mode for adjusting the vehicle seat: activating the drive apparatus to effect an adjustment of the seat assembly and/or the backrest sub-assembly relative to the floor assembly from an initial position to a target position, and that the control system be configured to perform steps in a second operating mode for measuring a weight acting upon the vehicle seat.

### CROSS-REFERENCE TO RELATED APPLICATION

This application claims priority pursuant to 35 U.S.C. 119(a) to German Patent Application No. 102025108810.1, filed Mar. 7, 2025, which application is incorporated herein by reference in its entirety.

### BACKGROUND

Some functions in today's vehicles are based upon seat occupancy detection. If a vehicle seat is occupied, the vehicle's control systems regularly check whether the corresponding seat belt is fastened. Furthermore, the triggering of airbags can be linked to seat occupancy. In some cases, these or other functions can be improved if it is not only detected whether the vehicle seat is occupied in some way or not, but also if the weight acting upon the vehicle seat is quantified. For example, an alarm for an unfastened seatbelt can be omitted if the vehicle seat is occupied by an object (e.g., a bag), but not by a passenger. The deployment of airbags can also be adapted to the weight of the passenger to achieve an optimized restraint effect.

In practice, for example, so-called bladder mats or piezo elements can be embedded in a seat to detect seat occupancy and perform an approximate weight measurement. However, such components require installation space and make manufacturing complex, due among other factors to the additional wiring.

German Patent No. 10 2006 061 669 A1 describes a method for determining the occupancy weight of a vehicle seat, wherein a seat element of the vehicle seat is adjustable by means of a drive unit, with the following steps: providing at least one measurement signal representing a state of the drive unit; controlling the drive unit for at least a specified time duration; during the control time period, detecting the measurement signal, determining a load torque from the measurement signal according to a motor model; and determining an indication of the occupancy weight of the seat element depending upon the load torque. An electric drive unit can be provided for adjusting the seat height. However, it has become apparent that improving the accuracy of the measurement is a worthwhile aim.

German Patent No. 10 2017 217 331 A1 describes a method for operating an electromechanical massage device of a seat, in particular of a motor vehicle, which comprises a massage drive with an electric motor, in which the electric motor is energized, a torque of the electric motor is detected, and a reference value is determined from this, and, on the basis of the reference value, an occupancy of at least one portion of the seat is determined.

German Patent No. 103 35 734 A1 relates to a method for seat occupancy detection for a motor vehicle with at least one actuating motor for seat adjustment. The electrical power supply to the actuating motor(s) for seat adjustment is detected during their activation and is evaluated as a measure of seat occupancy. However, the accuracy of this measurement also has room for improvement.

German Patent No. 10 2004 047 907 A1 describes how to control one or more electric motors in such a way that, from a current seating position, a vehicle seat is moved beyond a target position and then, shortly after overshooting the target position, a reversal of direction takes place, and the target position is reached in the opposite direction. The degree of overshooting of the target position is chosen so that the vehicle occupant is moved beyond the target position for only fractions of a second while seated. The movement in the opposite direction then correspondingly takes place in a comparable amount of time. This ensures sufficient upward or downward travel, which, without the need for start-up curves, provides reliable information for classifying the vehicle occupant or the object on the vehicle seat based upon the measurement signals of the electric motor or motors.

European Patent No. 1 000 327 B1 describes an apparatus and a method for detecting the weight of an object and/or an occupant on a vehicle seat. During operation of the vehicle, the measurement for weight detection is repeated at set intervals to detect changes in the weight force acting upon a vehicle seat.

### SUMMARY

The invention relates generally to a vehicle seat, a method, a corresponding computer program product, and a non-volatile, computer-readable storage medium.

An object of the invention is improving weight detection in vehicle seats. This object is achieved by the subject matter having the features of Claim 1. The proposed solution relates to a vehicle seat comprising a seat assembly, a backrest sub-assembly, a floor assembly bearing at least the seat assembly, an adjustment device for adjusting the seat assembly and/or the backrest sub-assembly relative to the floor assembly with a drive apparatus, and a control system coupled to the drive apparatus. It is provided that the control system be configured to perform the following step in a first operating mode for adjusting the vehicle seat: activating the drive apparatus to effect an adjustment of the seat assembly and/or the backrest sub-assembly relative to the floor assembly from an initial position to a target position, and that the control system be configured to perform the following steps in a second operating mode for measuring a weight acting upon the vehicle seat: activating the drive apparatus to effect an adjustment of the seat assembly and/or the backrest sub-assembly relative to the floor assembly; detecting at least one value of a parameter of the adjustment device and/or the drive apparatus during the adjustment; and determining the weight acting upon the vehicle seat based upon the at least one value of the parameter detected during the adjustment, wherein the control system is configured to prevent the activation of the drive apparatus in the first operating mode if an operating parameter detected by the control system is outside a specified range, and to allow the activation of the drive apparatus in the second operating mode if the operating parameter is outside the specified range.

According to this, a vehicle seat comprises a seat assembly, a backrest sub-assembly, a floor assembly supporting at least the seat assembly (e.g., the seat assembly and the backrest sub-assembly), an adjustment device for adjusting the seat assembly and/or the backrest sub-assembly relative to the floor assembly with a drive apparatus, and a control system coupled to the drive apparatus (e.g., communicatively and/or electrically). It is provided that the control system be configured to perform the following step in a first operating mode for adjusting the vehicle seat: activating the drive apparatus to effect an adjustment of the seat assembly and/or the backrest sub-assembly relative to the floor assembly from an initial position to a target position. Furthermore, the control system is configured to perform the following steps in a second operating mode to measure a weight acting upon the vehicle seat: (a) activating the drive apparatus to effect an adjustment of the seat assembly and/or the backrest sub-assembly relative to the floor assembly; (b) detecting at least one value of a parameter of the adjustment device and/or the drive apparatus during the adjustment; and (c) determining the weight acting upon the vehicle seat based upon the at least one value of the parameter detected during the adjustment. The control system is configured to prevent the activation of the drive apparatus in the first operating mode if an operating parameter detected by the control system is outside a specified range, and to allow the activation of the drive apparatus in the second operating mode if the operating parameter is outside the specified range.

If the operating parameter is outside the specified range, the control system prevents the activation of the drive apparatus from an inactive state in the first operating mode. An activation of the drive apparatus that has already been carried out (still within the specified range) is prevented in the first operating mode by deactivating the drive apparatus as soon as the operating parameter leaves the specified range.

This ensures that, in peripheral areas of the vehicle seat's operational capability, in particular the adjustment mechanism and the drive mechanism, a comfort setting according to the first operating mode, for example, is no longer permitted, while a weight measurement, which is safety-critical in some applications, is still allowed. Therefore, a reserve (in terms of the operating parameter) is maintained for weight measurement. In this way, a highly available weight measurement can be provided, thereby improving weight detection in vehicle seats.

The control system can be configured to allow the activation of the drive apparatus in the first operating mode and in the second operating mode if the operating parameter is within the specified range. Within the specified range, both the adjustment function and the weight measurement function are available.

The specified range can be a first specified range, and the control system can be configured to prevent the activation of the drive apparatus in the second operating mode if the operating parameter is outside the first specified range and outside a second specified range. The second specified range is, for example, outside the first specified range. The second specified range corresponds, for example, to the range in which the comfort setting is no longer available, but weight measurement is. If, however, the operating parameter is not only outside the first specified range, but also outside the second specified range, then weight measurement is no longer available - for example, to prevent damage.

The operating parameter is, for example, a temperature. An elevated temperature prevents, for example, the comfort setting, but not the weight measurement.

Specifically, the operating parameter can be the temperature of a drive motor of the drive apparatus. This can prevent the drive motor from overheating.

The operating parameter can also be an adjustment position of the adjustment device. This prevents a comfort setting from getting too close to a stop. It is to be noted that more than one operating parameter can be provided (e.g., temperature and adjustment position), wherein the described functionality is provided for each operating parameter.

For example, the specified range corresponds to a specified distance from an end stop or other limitation of the adjustment movement of the adjustment device.

In one design, the second operating mode can be deactivated. The control system can be configured to enlarge the specified range when the second operating mode is deactivated. For example, if no weight measurement is required, then it can be provided that no reserve is maintained for it, so that a larger range of the operating parameter allows for a comfort setting.

The parameter can be an electrical parameter, particularly a current strength, a voltage, or a power. Alternatively, or additionally, it can be provided that the parameter specifies a torque or a derived quantity from one of the aforementioned. Alternatively, or additionally, it can be provided that the parameter specifies a rotational speed (e.g., of the drive apparatus), particularly the maximum rotational speed reached during adjustment. These parameters allow for easy conversion to a weight, e.g., using a conversion rule and/or a table (lookup table, LUT). The parameter can relate in particular to one or more drive motor(s) of the drive apparatus. Optionally, the control system is configured (e.g., for each of two directions) to increase the voltage and/or current strength of the drive apparatus from a starting value (e.g., zero) until a component of the height adjustment device, particularly a drive motor of the drive apparatus, is set into motion from a standstill. The value of the parameter is then, for example, the value reached by the current strength or voltage. The control system can also be configured to stop the drive apparatus as soon as it has registered the movement. This allows the weight measurement to be achieved with minimal movement. The adjustment is therefore minimal and hardly noticeable, if at all, to a user of the seat. Alternatively (or additionally), it can be provided that the (or another) parameter indicates an adjustment path traveled within a certain (in particular, specified) time, particularly the length of this adjustment path, or an adjustment time required for a certain (in particular, specified) adjustment path. These parameters also allow for easy conversion into a weight, e.g., using a conversion rule and/or an LUT. In one embodiment, the at least one value of the parameter is the current integral of the current strength supplied to a drive motor of the drive apparatus over the adjustment duration and/or over the adjustment path. This allows for a particularly precise measurement.

The adjustment device can be a height adjustment device for adjusting the distance between the seat assembly and the floor assembly. This allows for particularly accurate weight measurements.

The control system can be configured to determine the weight acting upon the seat assembly based upon the detected values of the parameter from the adjustment in two opposite directions. This is based upon the idea that a height adjustment motor generates, through the adjustment, a torque which corresponds to a current. This current can be measured via the control system (which can comprise electronics located at the vehicle seat and/or a central vehicle control system) and used to evaluate the load increase. Furthermore, this is based upon the understanding that friction and tolerances can impair the accuracy of the weight measurement, but that a measurement in both adjustment directions allows such influences to be considered. This allows for a particularly precise weight determination with a very simple setup. The control system can be configured to activate the drive apparatus for weight measurement for a specified time and/or over a specified adjustment path (e.g., measured by the number of motor rotations) in the first direction and in the second direction.

In one embodiment, the control system is configured to determine the weight acting upon the vehicle seat based upon the detected values of the parameter from the adjustment in two opposite directions. The control system can be configured to first determine the current adjustment position and based upon that, select one of the two directions in which the adjustment will first take place. This can, for example, prevent an end stop from being reached during measurement.

The control system can be configured to perform a different calculation for each of the two different sequences of directions when determining the acting weight based upon at least one parameter value detected during the adjustment. The change in order can be considered by means of a computational compensation, e.g., with a different measure of self-heating of the drive apparatus.

The control system can be configured to consider the two different sequences of directions, when determining the acting weight based upon the at least one value of the parameter detected during the adjustment, by applying a characteristic curve of a position dependency of the parameter (because the change is always carried out from a certain position). This allows for easy calculation.

Furthermore, the control system can be configured, before measuring the weight acting upon the vehicle seat, to determine the direction of the last movement of the drive apparatus and to activate the drive apparatus in the same direction for the measurement of the acting weight. In this way, play during changeover can be prevented. Alternatively, or additionally, the control system can be configured (e.g., if a measurement in the previous direction would lead too close to an end stop) to effect an activation in the opposite direction before the measurement in this opposite direction, to compensate for backlash. Such active play compensation is only carried out, for example, if the measurement is made in the opposite direction to the previous movement. If the measurement is performed in two directions, then a compensation for the backlash can be provided in between. Alternatively, or additionally, a computational consideration of the play effect can be provided, e.g., by calculating a proportion in the adjustment path of the freedom of movement of the known play.

The control system can have a storage medium in which, for example, a model is stored that assigns a corresponding value of an acting weight to values of the parameter, to each possible value of the parameter. Using this model (e.g., in the form of an LUT), the weight can be determined in a particularly simple way. The model can also be a machine learning model which has been trained, for example, with different weight loads. Optionally, the model assigns a value of an acting weight to each of the parameter values (in particular, to each possible value of the parameter) for multiple possible setting positions of the height adjustment device. This allows for consideration of the fact that, due to the kinematics of the height adjustment device, the same torque is not required for an adjustment in every setting position.

Optionally, the model assigns a value of an acting weight to the values of the parameter (in particular, each possible value of the parameter) with respect to an adjustment in a first direction on the one hand and with respect to an adjustment in a second direction on the other (independent of each other). This can further improve the accuracy of the measurement. The control system is configured, for example, to determine the acting weight separately based upon the detected value of the parameter for the first direction and based upon the detected value of the parameter for the second direction. Optionally, the control system is also configured to determine the weight acting upon the seat assembly from the two weight values obtained in this way - for example, by forming an average value. Here, a weighted average can be calculated, for which each of the two individual values is multiplied by a weighting factor.

The control system can be configured to detect the values of the parameter for calibration when no weight is acting upon the vehicle seat. This can be done in the manner described above, i.e., by activating the drive apparatus to adjust the distance between the seat assembly and the floor assembly in the first direction and detecting the value of the parameter of the drive apparatus during the adjustment in the first direction; and, optionally, by activating the drive apparatus to adjust the distance between the seat assembly and the floor assembly in the second direction and detecting the value of the parameter of the drive apparatus during the adjustment in the second direction. Since the weight acting upon the seat assembly is known (0 kg), the detected values can be stored as a reference and/or used for calibration of, for example, the model. Calibration can correct aging-related effects, such as changes in efficiency, friction, etc., over the lifetime of the vehicle seat. Optionally, the control system is configured to automatically repeat the calibration at specified time intervals. This ensures consistently high accuracy of the weight determination.

The drive apparatus can comprise a brushless DC motor. Such motors allow for particularly precise adjustment of the adjustment speed by setting the rotational speed. In general, the adjustment speed can be measured via the rotational speed.

The control system is optionally configured to receive data on the occupancy of the vehicle seat from a camera or other detection device (such as radar). The data can include camera images or other data that the control system evaluates, e.g., to determine the size of a passenger sitting in the vehicle seat and/or their position on the vehicle seat. These data can be used with the determined weight. Furthermore, the determined weight can be corrected based upon the seat occupancy data; for example, the passenger's position on the vehicle seat can be used to correct a (too-low) measured weight.

The control system can comprise a memory in which a model is retrievably stored, with at least one relation is established between the weight acting upon the seat assembly and with the input values adjuster position and value of the measured parameter. In this way, a fast and reliable evaluation is possible.

The features described above can also be used to further develop the method and/or system described and/or claimed herein.

According to one aspect, a method is provided for determining a weight acting upon a vehicle seat, upon the vehicle seat according to any embodiment described herein. The vehicle seat comprises a seat assembly, a backrest sub-assembly, a floor assembly supporting at least the seat assembly, and an adjustment device (e.g., height adjustment device) for adjusting (e.g., a distance) the seat assembly and/or the backrest sub-assembly relative to the floor assembly with a drive apparatus. The method comprises the following steps: performing the following step in a first operating mode to adjust the vehicle seat: activating the drive apparatus to effect an adjustment of the seat assembly and/or the backrest sub-assembly relative to the floor assembly from an initial position to a target position; and performing the following steps in a second operating mode to measure a weight acting upon the vehicle seat: activating the drive apparatus to effect an adjustment of the seat assembly and/or the backrest sub-assembly relative to the floor assembly; detecting at least one value of a parameter of the adjustment device and/or the drive apparatus during the adjustment; and determining the weight acting upon the vehicle seat based upon the at least one value of the parameter detected during the adjustment, wherein a control system prevents, in the first operating mode, the activation of the drive apparatus if an operating parameter detected by the control system is outside a specified range, and, in the second operating mode, permits the activation of the drive apparatus if the operating parameter is outside the specified range. Regarding the advantages, reference is made to the above statements about the vehicle seat.

The method can comprise steps from the various embodiments of the control system described above.

According to one aspect, a computer program product is specified, comprising instructions which, when executed by one or more processor(s) (e.g., of the control system described above), cause the processor(s) to execute the method described above.

According to one aspect, a non-volatile, computer-readable storage medium is specified on which instructions are stored which, when executed by one or more processor(s) (e.g., of the control system described above), cause them to execute the method described above.

### BRIEF DESCRIPTION OF THE DRAWINGS

The idea underlying the invention will be explained in more detail below with reference to the exemplary embodiments shown in the figures, in which:

FIG. 1 shows a schematic view of a vehicle seat with a height adjustment device which is supported by a floor assembly, wherein the floor assembly is realized as a longitudinal adjustment device by way of example;

FIG. 2 shows a view of a seat assembly of a vehicle seat;

FIG. 3 shows a plan view of the arrangement according to FIG. 2;

FIG. 4 shows a partially enlarged view of the arrangement according to FIG. 2, showing a drive apparatus on a pivot element for connecting the seat assembly to a floor assembly in the form of a longitudinal adjustment device;

FIG. 5 shows an alternatively realized drive apparatus for the vehicle seat according to FIG. 1;

FIG. 6 shows a method for determining a weight acting upon the vehicle seat according to FIG. 1;

FIG. 7 shows the current strength of a drive motor versus the position of a component adjusted by it; and,

FIG. 8 shows a diagram with examples of specified ranges of operating parameters.

### DETAILED DESCRIPTION OF THE INVENTION

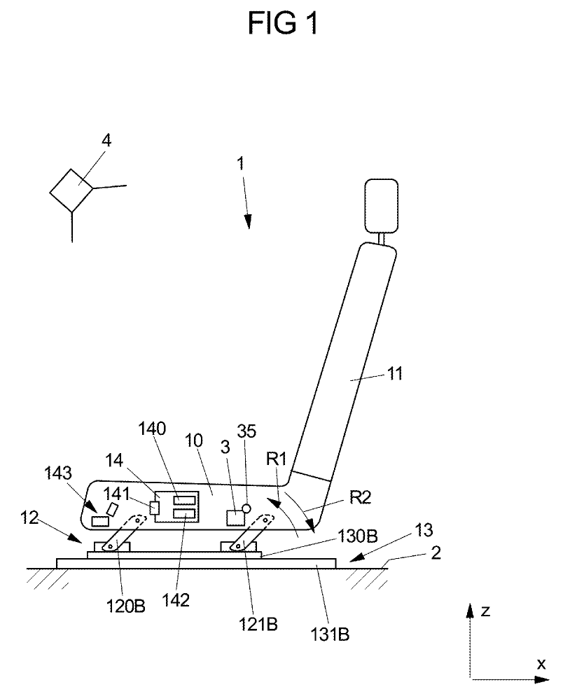

FIG. 1 shows a vehicle seat 1, which can be arranged, for example, as a front seat or as a rear seat in the second or third row of seats in a vehicle. The vehicle seat 1 has a seat component assembly 10, on which a backrest assembly 11 is arranged in a tilt-adjustable manner and which is connected via a height adjustment device 12 to a floor assembly 13 in the form of a longitudinal adjustment device for longitudinal adjustment of the vehicle seat 1 along a longitudinal direction X.

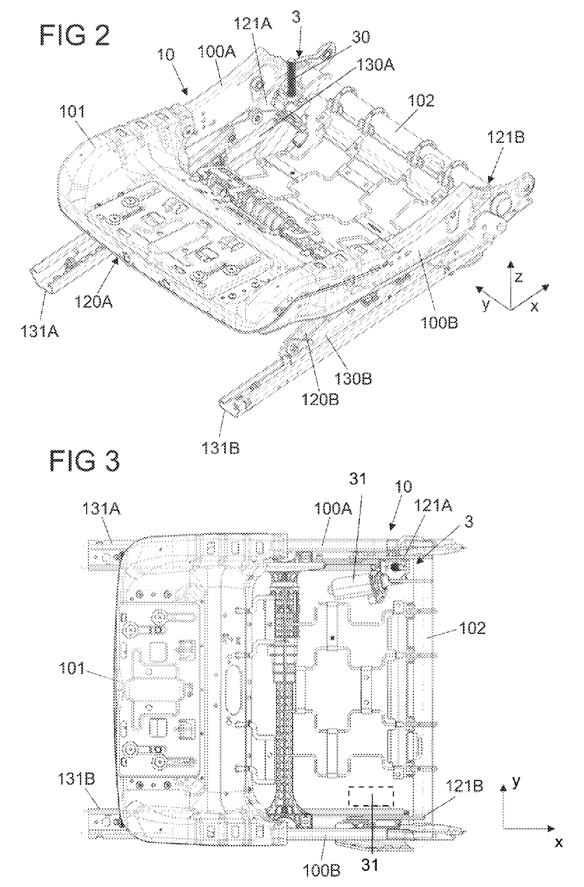

The longitudinal adjustment device 13 typically has, as can be seen from FIG. 1 in conjunction with FIGS. 2 and 3, two pairs of guide rails 130A, 131A, 130B, 131B, each arranged on one side of the seat assembly 10 and spaced apart from each other along a transverse direction Y perpendicular to the longitudinal direction X. The lower guide rails 131A, 131B are firmly connected to a vehicle floor 2 and can be firmly connected to it in a pre-assembly state. In contrast, upper guide rails 130A, 130B are coupled to pivot elements 120A, 121A, 120B, 121B of the height adjustment device 12. The floor assembly 13 is connected to the seat assembly 10 via the height adjustment device 12.

The pivot elements 120A, 121A, 120B, 121B together with the upper guide rails 130A, 130B and side frame parts 100A, 100B of the seat assembly 10 form two pairs of four-pivot systems. The pivot elements 120A, 121A, 120B, 121B are each pivotably connected at one end to the correspondingly associated upper guide rail 130A, 130B and at the other end are pivotably connected to the seat assembly 10, e.g., to a cross tube 102 extending pivotably between the frame parts 100A, 100B of the seat assembly 10 (or are connected to another part of the seat assembly 10) such that, by pivoting the pivot elements 120A, 121A, 120B, 121B, the height position of the seat assembly 10 can be changed along a height direction Z (perpendicular to the longitudinal direction X and transverse direction Y). This involves changing the distance between the seat assembly 10 and the floor assembly 13. The height adjustment device 12 is thus configured to adjust a distance between the seat assembly 10 and the floor assembly 13. To effect an adjustment, the height adjustment device 12 comprises (at least) one drive apparatus 3 (with one or more drive motors).

The floor assembly, i.e., here, the longitudinal adjustment device 13, bears the seat assembly 10. The seat assembly 10 bears the backrest assembly 11.

The height adjustment device 12 is an adjustment device for adjusting the seat assembly 10 (and, because the backrest assembly 11 is mounted on the seat assembly 10 in the example shown, also the backrest assembly 11) relative to the floor assembly, i.e., here, to the longitudinal adjustment device 13, with the drive apparatus 3.

The vehicle seat 1 further comprises a control system 14 operatively coupled to the drive apparatus 3, which system is configured to perform the following steps:
performing the following step in a first operating mode to adjust the vehicle seat 1:
activating the drive apparatus 3 to effect an adjustment of the seat assembly 10 and the backrest sub-assembly 11 relative to the floor assembly 13 from an initial position to a target position;
the vehicle seat 1:
activating the drive apparatus 3 to effect an adjustment of the seat assembly 10 and/or the backrest sub-assembly 11 relative to the floor assembly 13;
detecting at least one value of a parameter of the adjustment device 12 and/or the drive apparatus 3 during the adjustment; and
determining the weight acting upon the vehicle seat 1 based upon the at least one value of the parameter detected during the adjustment.

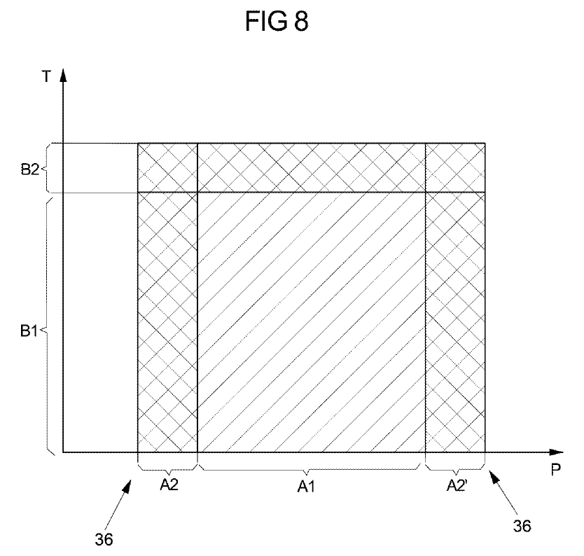

It is provided that the control system 14 be configured to prevent, in the first operating mode, the activation of the drive apparatus 3 if an operating parameter detected by the control system 14 is outside a specified range A1, B1 (see FIG. 8), and to allow the activation of the drive apparatus 3 in the second operating mode if the operating parameter is outside the specified range A1, B1.

The drive apparatus 3 is in this case the drive apparatus of the height adjustment device 12.

Furthermore, the control system 14 can be configured to start the adjustment by the actuation of a button 143. It can be provided that the drive apparatus 3 remain activated as long as the button 143 is actuated (or a stop is reached). For example, a seat user presses button 143 starting from the initial position of vehicle seat 1 for as long as the vehicle seat 1 is to be adjusted. In the target position, the seat user then stops actuating the button 143, so that the drive apparatus 3 is deactivated. The control system can alternatively or additionally be configured to perform the adjustment in response to an actuation of the button 143 from the initial position to a stored position (e.g., a memory position) as the target position, even if the button 143 has already been released. The button 143 can be mounted on the vehicle seat 1, e.g., as illustrated in FIG. 1, on the seat assembly 10. Alternatively, the button 143 (which can also be called an actuation panel and can be a physical unit or a button displayed on a screen) is mounted, for example, on a vehicle door or a console of the vehicle with vehicle seat 1. The button 143 is operatively connected to the rest of the control system 14, e.g., via an electrical, optical, or other cable.

According to FIG. 1, an adjustment in a first direction R1 increases the distance between the seat assembly 10 and the floor assembly 13, while an adjustment in the opposite, second direction R2 decreases the distance between the seat assembly 10 and the floor assembly 13. Only a minimal adjustment path is required for weight determination, e.g., a few mm in relation to the distance between the seat assembly 10 and the floor assembly 13.

The drive apparatus 3 can be activated with different adjustment speeds and has a minimum and a maximum adjustment speed. The control system 14 is configured to activate the drive apparatus 3 with the minimum adjustment speed, e.g., first in the first direction R1 and then in the second direction R2, or alternatively with an adjustment speed that is less than the maximum adjustment speed (or an adjustment speed for a regular setting). As a result, the weight measurement is barely or not at all perceptible to a user of the seat.

The parameter here is an electrical parameter, e.g., the current strength of at least one drive motor 31 of the drive apparatus 3, e.g., the total current drawn by it or the current strength of one phase of the drive motor 31. Alternatively, or additionally, the applied power can also be used as a parameter. The current strength corresponds to an associated torque (of the drive motor or drive motors) of the drive apparatus 3. Depending upon the size of the acting weight, e.g., due to a passenger, a larger or smaller torque must be applied by the drive apparatus 3 for an adjustment, e.g., by a specified adjustment path. Therefore, a predefined relation between the current strength (in general, the parameter) and the acting weight (possibly depending upon the current adjustment position of the height adjustment device 12) can be used by the control system 14 to determine the weight. By performing the measurement in both adjustment directions R1, R2, inaccuracies that have different effects in the different directions can be factored out, e.g., by an (optionally weighted) averaging of weight values determined separately for the two directions R1, R2. Inaccuracies due to friction, tolerances, wear and tear, and the like can be factored out using empty measurements with the vehicle seat 1 unoccupied. For example, the difference is formed between a current strength (in general: values of the parameter) during an empty measurement downwards and a weight measurement downwards with occupancy and is then multiplied by a first factor to determine a weight in the measurement during the downward adjustment. Furthermore, the difference is formed between a current strength (in general: values of the parameter) during a weight measurement upwards with occupancy and an empty measurement upwards and is then multiplied by a second factor to determine a weight in the measurement during the upward adjustment. The first factor and the second factor can be different from each other or the same. The weight is then determined, for example, based upon the sum of the two weight values.

The current strength (in general: the value of the parameter) for a given direction can be determined as an average value over an adjustment path. Furthermore, the integral over the current strength over the adjustment time period can be used as a parameter. Optionally, the starting up of the drive motor is excluded here.

The parameter can also specify, for example, a maximum speed reached during the adjustment, an adjustment path traveled within a certain time, or an adjustment time required for a specific adjustment path.

The specified relation between the value of the parameter and the weight is stored, for example, in a storage medium 140 of the control system 14. The relation can be a model that assigns a value of an acting weight to each possible value of the current integral, the current strength, or another parameter. Because these relations depend upon the direction of adjustment in the example shown, the model also assigns a value of an acting weight to each possible value of the current strength with respect to an adjustment in the first direction R1 and with respect to an adjustment in the second direction R2, independently of each other. And because in the example shown these relations also depend upon the adjustment position, the model assigns a value of an acting weight to each possible value of the current integral, the current strength, or another parameter for all possible adjustment positions of the height adjustment device 12. The model can comprise an LUT and/or a trained machine learning model.

To create the LUT and/or the training data for the machine learning model, test masses (e.g., 0 kg, 10 kg, 20 kg, 40 kg, and 80 kg, optionally with finer subdivisions) with various known weights can be placed on the seat assembly 10 and the values of the parameter (in particular, at multiple adjustment positions) can be determined in the manner described above. In this way, a table with factors can be determined which assigns a weight value to each parameter value (e.g., current strength) for each adjustment position. This table can be stored on the storage medium. Interpolation is possible between any two entries in the table.

To correct for changes in efficiency and due to friction, etc., the control system 14 is configured to perform (e.g., regular) calibration runs. The control system 14 is configured to detect the parameter values for calibration when no weight is acting upon the vehicle seat 1.

A camera 4 (or other detection device such as a radar) is directed toward the vehicle seat 1 to capture the size and position or the like of a passenger seated in the vehicle seat 1 in camera images. The camera 4 is directly or indirectly communicatively connected to the control system 14, so that the control system 14 receives data about the occupancy of the vehicle seat 1 from the camera 4. These data can be in the form of the recorded images or in the form of already-evaluated data about weight, position, or the like. By combining the determined weight with information on size and position, the seat occupancy can be detected particularly precisely. A weight measurement that has been incorrectly determined, e.g., due to an incorrect seating position, can also be corrected in this way. For this purpose, a correction table can be stored in the storage medium and assigns correction factors to different seating positions (e.g., further forwards, further back). Since modern vehicles are increasingly equipped with passenger cameras, such a measure is particularly easy to implement. For this purpose, the control system 14 is configured to receive seat occupancy data based upon the camera images, e.g., via a dedicated interface 141.

The exemplary design of the height adjustment device 12 is explained in more detail below with reference to FIGS. 2-4.

The frame parts 100A, 100B of the seat assembly 10 are connected to each other at a rear end via the cross tube 102. The cross tube 102 is (in this example) pivotably mounted on the frame parts 100A, 100B and bears the associated rear pivot elements 121A, 121B.

In a frontal region, a seat pan 101 is arranged on the frame parts 100A, 100B to form a seat surface of the seat assembly 10.

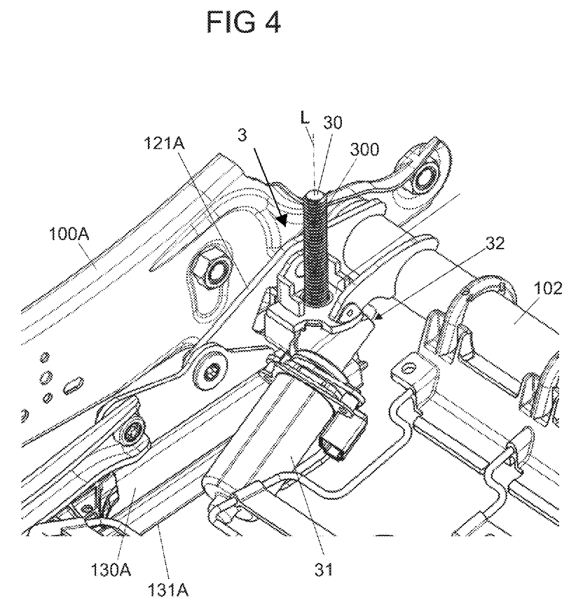

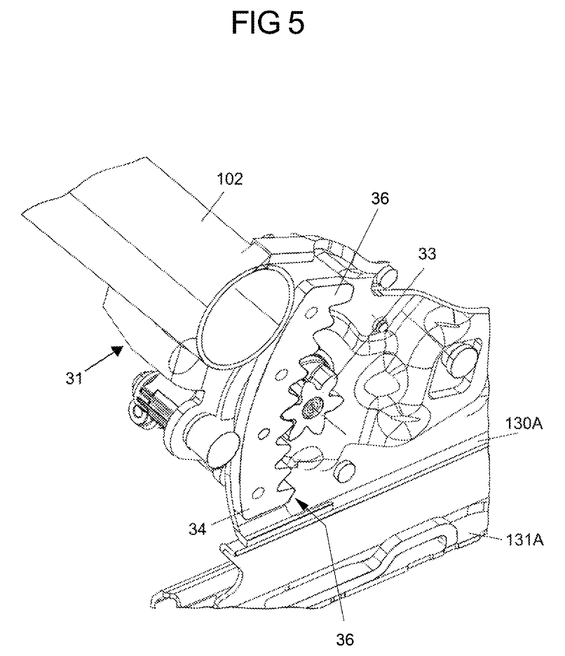

In the exemplary embodiment shown, the drive apparatus 3 of the height adjustment device 12 is arranged by way of example on the rear pivot element 121A on the side of the guide rail pair 130A, 131A, as can be seen from FIGS. 2 and 3 in conjunction with FIG. 4. The drive apparatus 3 is configured as a spindle drive and serves to introduce an adjusting force into the pivot element 121A, so that, by pivoting the pivot element 121A, the pivot elements 120A, 121A, 120B, 121B can be pivoted as a whole and thereby the height position of the seat assembly 10 can be adjusted, i.e., the distance between the seat assembly 10 and the floor assembly 13 is adjusted.

At a set seat height, the seat assembly 10 is held in position on the pivot element 121A via the drive apparatus 3. The drive apparatus 3 is configured to be loadable such that forces acting upon the seat assembly 10 can be absorbed and dissipated.

Referring now to FIGS. 2-4, the drive apparatus 3 has a spindle 30 which is pivotably connected at one end to the associated guide rail 130A via a bearing element.

The pivot element 121A is coupled to an attachment part connected to the guide rail 130A and is pivotably mounted on the guide rail 130A (here, via a bearing bolt).

With a threaded shaft 300 on which an external thread is formed, the spindle 30 extends substantially perpendicularly from the end connected to the guide rail 130A. The spindle 30 is operatively connected to an adjustment gearbox 32 such that, by driving the adjustment gearbox 32, longitudinal adjustment can take place along a longitudinal extension direction L relative to the spindle 30, in order in this way to change the length of a between the adjustment gearbox 32 and the end of the spindle 30 pivotably mounted on the guide rail 130A, and thereby to introduce an adjusting force into the pivot element 121A and thus adjust the distance between the seat assembly 10 and the floor assembly 13.

The adjustment gearbox 32 has a spindle nut and a drive element in the form of a drive worm which stands in toothed engagement with an external toothing of the spindle nut via a worm gear. The drive element is driven by a drive motor 31, so that the spindle nut can be set into a rotary motion by the drive motor 31 and via a motor shaft of the drive motor 31. The spindle nut engages with the external thread of the spindle 30 via an internal thread in such a way that, by rotation, the spindle nut rolls on the spindle 30 and is thereby adjusted longitudinally along the longitudinal direction L relative to the spindle 30.

Optionally, the height adjustment device 12 comprises an additional drive motor 31, which can be arranged, for example, in mirrored fashion to the drive motor 31 on the rear pivot element 121B on the side of the guide rail pair 130B, 131B. This is illustrated schematically in FIG. 3. Based upon the values of the parameters of both drive motors (e.g., the sum), the acting weight can be determined particularly accurately.

The drive motors 31 are brushless direct current motors (BLDC motors) whose rotational speed and torque can be adjusted particularly precisely.

The adjustment gearbox 32 is pivotably mounted on the pivot element 121A. In an adjustment movement in which the length of the portion of the spindle 30 running between the adjustment gearbox 32 and the rail-side end is changed, the adjustment gearbox 32 can thus pivot on the pivoting element 121A. In this way, a change in the position of the pivot element 121A relative to the floor assembly 13 can be compensated for.

The drive motor 31 is pivotably mounted on the pivot element 121A via the adjustment gearbox 32. When the pivot element 121A is adjusted, the drive motor 31 and the adjustment gearbox 32 are thus moved together with the pivot element 121A.

FIG. 5 shows an example of an alternatively configured drive apparatus for the vehicle seat according to FIG. 1, which has a drive motor 31 mounted on the seat assembly 10, which motor drives a pinion 33 via a gearbox. The pinion 33 meshes with a curved toothed segment 34, which is attached to the upper guide rail 130A. Otherwise, the functionality is as described above.

Upper and lower end stops 36 are provided which mechanically limit adjustability. Such end stops are also provided in the height adjustment according to FIGS. 2-4.

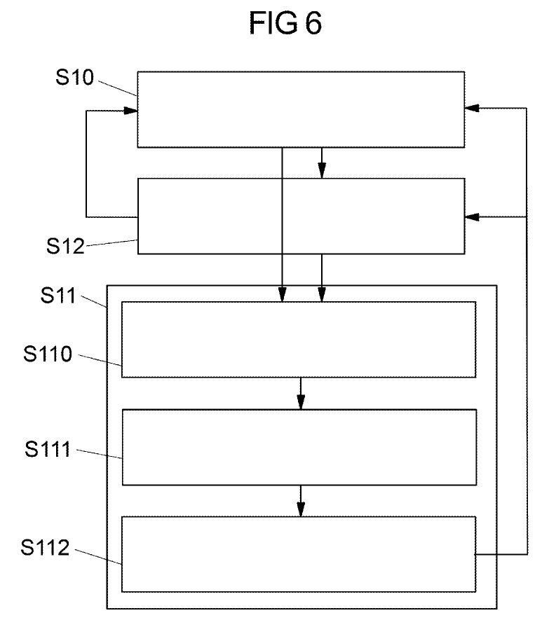

FIG. 6 shows a method for determining a weight acting upon the vehicle seat 1, wherein the method comprises the following steps:

Step S10: Performing the following step in a first operating mode to adjust the vehicle seat 1: activating the drive apparatus 3 to effect an adjustment of the seat assembly 10 and/or the backrest sub-assembly 11 relative to the floor assembly 13 from an initial position to a target position.

Step S11: Performing the following steps in a second operating mode to measure a weight acting upon the vehicle seat 1:

Step S110: Activating the drive apparatus 3 to effect an adjustment of the seat assembly 10 and/or the backrest sub-assembly 11 relative to the floor assembly 13.

Step S111: Detecting at least one value of a parameter of the adjustment device 12 and/or the drive apparatus 3 during the adjustment.

Step S112: Determining the weight acting upon the vehicle seat 1 based upon the at least one value of the parameter detected during the adjustment.

In the first operating mode, the activation of the drive apparatus 3 is prevented if an operating parameter detected by the control system 14 is outside a specified range A1, B1 (see FIG. 8), and, in the second operating mode, the activation of the drive apparatus 3 is permitted if the operating parameter lies outside the specified range A1, B1.

Furthermore, a step S12 can be provided in which neither an adjustment of the vehicle seat 1 from an initial position to a target position nor a weight measurement is carried out. This corresponds, for example, to a third operating mode. In the third operating mode, the drive apparatus 3 is, for example, inactive. The method can proceed from step S10 to step S12 or can carry out step S11 directly after step S10. From step S12, the method can continue with step S10 or with step S11. From step S11, the method can continue with step S10 or with step S12.

Regarding specific embodiments of the method, reference is made to the above and following statements about the control system 14, to avoid repetition. The method can comprise corresponding method steps which correspond to the functioning described herein of the control system 14.

The storage medium 140 contains a computer program product comprising instructions which, when executed by one or more computers, when executed by the control system 14 (e.g., by its processor 142), cause it/them to carry out the method described above.

Since measuring a large weight at a lower rotational speed can be more accurate than at a high rotational speed (and conversely, measuring a small weight at a higher rotational speed can be more accurate), it can be provided that the control system 14 set the adjustment speed based upon an input value, e.g., based upon a previously determined weight acting upon the vehicle seat 1. Alternatively, e.g., if such a measurement is not (yet) available, another measuring device can be used, e.g., as already described, the camera 4 or the like. An initial estimated value of the weight makes possible the use of an optimal adjustment speed for that weight. For example, the storage medium 140 stores for each possible weight value a corresponding adjustment speed, or a functional relation that outputs a corresponding adjustment speed for an entered weight.

Other conditions can also influence the optimal adjustment speed, e.g., temperature or the like. Therefore, a temperature, e.g., of the environment, can be used by a component of the height adjustment device 12 or the drive apparatus 3 as a pre-selection parameter for the adjustment speed. The adjuster current increases sharply at low temperatures. At low temperatures (e.g., below a specified threshold), the rotational speed can be reduced, resulting in a lower phase voltage. A temperature measurement value which is provided to the control system 14, e.g., by a temperature sensor 35 for measuring the temperature of the drive apparatus 3 (see FIG. 1), is then used, for example, to read in a corresponding adjustment speed (e.g., via a tabular or functional relation between them).

Therefore, it can generally be provided that the control system 14 sets the variable adjustment speed based upon an input value.

Optionally, a startup current (i.e., at different rotational speeds during a rotational speed ramp) is excluded from the measurement. Alternatively, this startup current is also measured.

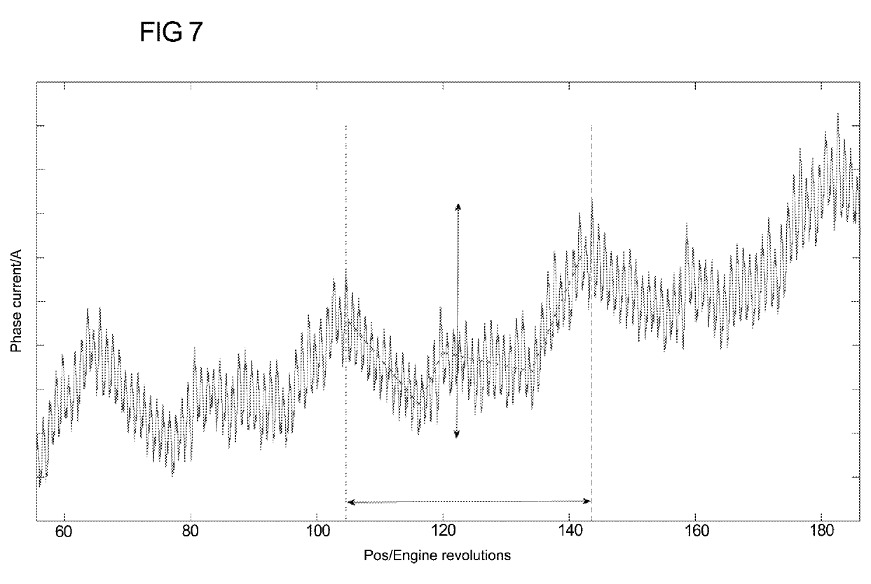

FIG. 7 illustrates an exemplary current profile of the drive apparatus 3. Specifically, FIG. 7 shows a curve of the current strength of one phase of the drive motor 31 of the drive unit 3 against the adjustment path. The x-axis illustrates the position as the number of motor revolutions. One complete revolution of the motor shaft here corresponds to one motor revolution.

The diagram in FIG. 7 shows that, within one motor revolution, the current strength fluctuates between a maximum and a minimum, so that the current profile over multiple motor revolutions has a wavy structure. If the average value (or the integral) of the current strength is now calculated for each motor revolution (or another accompanying window), then these fluctuations per motor revolution can be factored out. These average values are illustrated by a dashed line. However, the average values also show a variable curve. A repeating pattern can be seen, which extends over a fixed number of engine revolutions and then repeats. Such a pattern is identified in the representation by vertical lines. This pattern results, for example, from the design of the drive apparatus 3 and/or the adjustment unit, from the design of the adjustment gearbox 32.

As can be seen in FIG. 7, the individual portions also differ from each other, each with a complete pattern. Thus, the pattern located in the middle of the diagram has a higher overall average current strength than the pattern to its left and a lower one than the pattern to its right. Furthermore, the maximum deviation of the current strength within a pattern, i.e., the difference between the lowest and highest values of the current strength within a pattern, can differ between the individual portions. This difference is shown by way of example for the middle pattern in FIG. 7 as a vertically running double arrow.

The acting weight can be determined from the measured values shown, e.g., by determining the weight from the average current strength of a pattern using a specified conversion rule (e.g., an LUT). For example, in each position of the height adjustment device 12, the conversion rule assigns a value of the weight to a value of the current strength. The accuracy of the measurement can be determined from the maximum deviation.

For example, the current integral of the current strength supplied to the drive motor 31 (for one phase or the total over all phases) of the drive apparatus 3 over the relevant adjustment time duration and/or over the relevant adjustment path is used as the value of the parameter.

FIG. 8 illustrates, by way of example, two operating parameters: the temperature T of the drive motor 31 and the adjustment position P of the height adjustment device 12.

The control system 14 can measure the temperature T using the temperature sensor 35. The adjustment position P can be determined by the control system as the number of motor revolutions starting from a starting point. The adjustment position P corresponds (according to the kinematics) to a position along the height direction Z.

FIG. 8 illustrates, by way of example, the specified range A1 of the adjustment position P. If the height adjustment device 12 with the drive apparatus 3 is located within this specified range A1 (here, an interval in the number of motor revolutions of the motor shaft), then the first operating mode, i.e., the adjustment (from an initial position to a target position), is enabled. The second operating mode, i.e., weight measurement, is also enabled. If a seat user wishes to make an adjustment, the drive apparatus 3 can be activated accordingly. If the weight needs to be measured, the drive apparatus can also be activated for this purpose.

However, if the operating parameter, in this example the adjustment position P, lies outside the specified range A1, then the first operating mode is not enabled. The activation of the drive apparatus 3 for the purpose of adjustment is then prevented. Therefore, an ongoing adjustment leads to the deactivation of the drive apparatus 3 at the boundary of the specified range A1. If the drive apparatus 3 is already outside the specified range A1, then the drive apparatus 3 cannot be activated for the purpose of adjustment.

In the present case, the specified range A1 is the first specified range A1. In this case, it is surrounded by second specified ranges A2, A2'. In the second specified ranges A2, A2', the first operating mode is not enabled, but the second operating mode is enabled. Outside the first specified range A1 and the second specified ranges A2, A2', the second operating mode is also no longer enabled. In the present case, the second specified ranges A2, A2' are limited by the upper and lower end stops 36, but a control-related limitation regarding the corresponding adjustment positions P would also be possible. The second specified ranges A2, A2' are soft-stop ranges for adjustability. The boundaries facing the first specified range A1 serve as control-related end stops for the adjustment. The first specified range A1 is defined by specified distances from the end stops 36 of the adjustment device 12. The second specified ranges A2, A2' serve as a power reserve for the weight measurement.

However, if the weight measurement is temporarily not necessary, the second operating mode can be deactivated. Then the first specified range A1 can be enlarged.

Another example of an operating parameter is the temperature - here, for example, of the drive motor 31. The first specified range B1, extends up to a maximum operating temperature for carrying out an adjustment. The second specified range B2 defines a temperature reserve for carrying out a weight measurement. The functioning is otherwise as explained above for adjustment position P.

When moving from an initial position to a target position, drive motor 31 can heat up by up to 10°C. In the manner described, a thermal protection can be created for the drive motor 31 that enables weight measurement even when thermal protection is active.

Here, the control system 14 is configured to monitor both operating parameters mentioned as examples, in the manner described. Therefore, activation of the drive apparatus in the first operating mode is only possible in the singly hatched region in FIG. 8, i.e., if both operating parameters are located in their respective first specified range A1, B1. In the cross-hatched regions, the drive apparatus 3 can be activated only for the second operating mode.

Of course, it can also be provided that only one operating parameter be monitored in the manner described. Furthermore, it is conceivable that two operating parameters (e.g., as described above, the adjustment position P and the temperature T) or more than two operating parameters be monitored in the manner described.

The control system 14 comprises the computer-readable storage medium 140 in which a model is stored with which at least one relation is established between the weight acting upon the vehicle seat 1, in particular on the seat assembly 10, and the adjuster position (in particular, of the height adjustment device 12) and/or the value of the measured parameter (e.g., the current strength of the drive motor, e.g., of one of multiple phases or the current strengths of all phases).

### LIST OF REFERENCE SIGNS

1 Vehicle seat

10 Seat component assembly

100A, 100B Frame part

101 Seat tub

102 Cross tube

11 Backrest assembly

12 Height adjustment device

120A, 120B Pivot element

121A, 121B Pivot element

13 Floor assembly (longitudinal adjustment device)

130A, 130B Guide rail

131A, 131B Guide rail

14 Control system

140 Storage medium

141 Interface

142 Processor

143 Sensor

2 Vehicle floor

3 Drive apparatus

30 Spindle

300 Threaded shaft

31 Drive motor

310 Motor shaft

32 Adjustment transmission

33 Sprockets

34 Tooth segment

35 Temperature sensor

36 End stop

4 Camera

L Longitudinal direction of extension

A1, B1 First specified range

A2, A2', B2 Second specified range

P Adjustment position

R1, R2 Direction

T Temperature

X Longitudinal direction

Y Transverse direction

Z Height direction

What is claimed is:

1. A vehicle seat comprising:
a seat assembly,
a backrest sub-assembly,
a floor assembly that bears at least the seat assembly,
an adjustment device for adjusting the seat assembly and/or the backrest sub-assembly relative to the floor assembly with a drive apparatus, and
a control system coupled to the drive apparatus, wherein the control system is configured to perform the following step in a first operating mode for adjusting the vehicle seat:
activating the drive apparatus to effect an adjustment of the seat assembly and/or the backrest sub-assembly relative to the floor assembly from an initial position to a target position;
that the control system is configured to perform the following steps in a second operating mode for measuring a weight acting upon the vehicle seat:
activating the drive apparatus to effect an adjustment of the seat assembly and/or the backrest sub-assembly relative to the floor assembly;
detecting at least one value of a parameter of the adjustment device and/or the drive apparatus during the adjustment; and
determining the weight acting upon the vehicle seat based upon the at least one value of the parameter detected during the adjustment, wherein the control system is configured to prevent the activation of the drive apparatus in the first operating mode if an operating parameter detected by the control system is outside a specified range, and to allow the activation of the drive apparatus in the second operating mode if the operating parameter is outside the specified range.

2. The vehicle seat according to claim 1, wherein the control system is configured to allow the activation of the drive apparatus in the first operating mode and in the second operating mode if the operating parameter is within the specified range.

3. The vehicle seat according to claim 1, wherein the specified range is a first specified range, and the control system is configured to prevent the activation of the drive apparatus in the second operating mode if the operating parameter is outside the first specified range and outside a second specified range, wherein the second specified range is outside the first specified range.

4. The vehicle seat according to claim 1, wherein the operating parameter is a temperature.

5. The vehicle seat according to claim 4, wherein the operating parameter is a temperature of a drive motor of the drive apparatus.

6. The vehicle seat according to claim 1, wherein the operating parameter is an adjustment position of the adjustment device.

7. The vehicle seat according to claim 6, wherein the specified range corresponds to a specified distance from an end stop of the adjustment device.

8. The vehicle seat according to claim 1, wherein the second operating mode can be deactivated, and the control system is configured to enlarge the specified range when the second operating mode is deactivated.

9. The vehicle seat according to claim 1, wherein the adjustment device is a height adjustment device for adjusting a distance between the seat assembly and the floor assembly.

10. The vehicle seat according to claim 1, wherein the control system is configured to determine a weight acting upon the vehicle seat based upon the detected values of the parameter from the adjustment in two opposite directions, wherein the control system is configured to determine the current adjustment position and, based upon this, to select one of the two directions in which the adjustment is carried out first.

11. The vehicle seat according to claim 10, wherein the control system is configured to perform a different calculation for each of the two different sequences of directions when determining the acting weight based upon the at least one value of the parameter detected during the adjustment.

12. The vehicle seat according to claim 10, wherein the control system is configured to take into account the two different sequences of directions, when determining the acting weight based upon the at least one value of the parameter detected during the adjustment, by applying a characteristic curve of a position dependence of the parameter.

13. The vehicle seat according to claim 1, wherein the control system is configured to determine the direction of the last movement of the drive apparatus before measuring the weight acting upon the vehicle seat, and to effect the activation of the drive apparatus for measuring the acting weight in the same direction, or, before measuring in the opposite direction, to effect an activation in this opposite direction in order to compensate for backlash.

14. The vehicle seat according to claim 1, wherein the control system has a storage medium in which a model is stored which assigns to each possible value of the parameter a value of an acting weight, wherein, for multiple possible setting positions of the adjustment device, in each case the model assigns a value of an acting weight to each possible value of the parameter.

15. The vehicle seat according to claim 1, wherein the control system is configured to detect the values of the parameter for calibration when no weight is acting upon the vehicle seat.

16. A method for determining a weight acting upon a vehicle seat, the vehicle seat comprising a seat assembly, a backrest sub-assembly, a floor assembly bearing at least the seat assembly, and an adjustment device for adjusting the seat assembly and/or the backrest sub-assembly relative to the floor assembly with a drive apparatus, in particular according to any of the preceding claims, the method comprising the following steps:
performing the following step in a first operating mode to adjust the vehicle seat:
activating the drive apparatus to effect an adjustment of the seat assembly and/or the backrest sub-assembly relative to the floor assembly from an initial position to a target position; and
performing the following steps in a second operating mode to measure a weight acting upon the vehicle seat:
activating the drive apparatus to effect an adjustment of the seat assembly and/or the backrest sub-assembly relative to the floor assembly;
detecting at least one value of a parameter of the adjustment device and/or the drive apparatus during adjustment; and
determining the weight acting upon the vehicle seat based upon at least one value of the parameter detected during adjustment, wherein a control system prevents the activation of the drive apparatus in the first operating mode if an operating parameter detected by the control system is outside a specified range, and allows the activation of the drive apparatus in the second operating mode if the operating parameter is outside the specified range.

17. A computer program product comprising instructions which, when executed by one or more processor(s), cause the processor(s) to execute the method according to claim 16.

18. A non-volatile, computer-readable storage medium on which instructions are stored which, when executed by one or more processor(s), cause the processor(s) to execute the method according to claim 16.

19. The vehicle seat according to claim 2, wherein the specified range is a first specified range, and the control system is configured to prevent the activation of the drive apparatus in the second operating mode if the operating parameter is outside the first specified range and outside a second specified range, wherein the second specified range is outside the first specified range.

20. The vehicle seat according to claim 2, wherein the operating parameter is a temperature.
